(19) United States
(12) Patent Application Publication
(10) Pub. No.: US 2019/0353301 A1
(43) Pub. Date: Nov. 21, 2019

(54) MOBILE STORAGE DEVICE

(71) Applicant: LIH YANN INDUSTRIAL CO., LTD., Taichung City (TW)

(72) Inventor: Po-Lin LIAO, Taichung City (TW)

(21) Appl. No.: 15/980,125

(22) Filed: May 15, 2018

(51) Int. Cl. F16N 31/00

(52) U.S. Cl. CPC F16N 31/006

(57) ABSTRACT

A mobile storage device is provided, including: a receiving body, including an inner space, an inlet which is communicated with the inner space, a holding portion and a side face which is opposite to the holding portion; at least one rotatable member, disposed on the receiving body and protruding beyond the receiving body, and the inlet being located between the at least one rotatable member and the holding portion.

### BACKGROUND OF THE INVENTION

### Field of the Invention

The present invention relates to a mobile storage device.

### Description of the Prior Art

In liquid receiving operation, for example, during changing of oil of a vehicle, a storage device is disposed under the bottom of the vehicle to receive oil, and then the storage device is removed after the operation is finished. However, the storage device filled with liquid is very heavy and inconvenient to be moved. It is easy to damage the bottom of the storage device due to frictional contact of the ground. In addition, since the conventional storage device cannot be placed upright, manpower is required to discharge the liquid in the storage device to allow the liquid to flow toward the outlet, which results in inconvenience in use.

The present invention is, therefore, arisen to obviate or at least mitigate the above-mentioned disadvantages.

### SUMMARY OF THE INVENTION

The main object of the present invention is to provide a mobile storage device which can rest upright and is convenient for movement.

To achieve the above and other objects, the present invention provides a mobile storage device, including: a receiving body, including an inner space, an inlet which is communicated with the inner space, a holding portion and a side face which is opposite to the holding portion; at least one rotatable member, disposed on the receiving body and protruding beyond the receiving body, and the inlet being located between the at least one rotatable member and the holding portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are stereograms of a preferable embodiment of the present invention;

FIG. 3 is a cross-sectional view of a preferable embodiment of the present invention;

FIG. 4 is a partially cross-sectional view of a preferable embodiment of the present invention from another viewpoint;

FIG. 5 is a breakdown drawing of a preferable embodiment of the present invention;

FIGS. 6 and 7 are schematic diagrams of a preferable embodiment of the present invention in use.

### DETAILED DESCRIPTION OF THE PREFERRED EMBODIMENTS

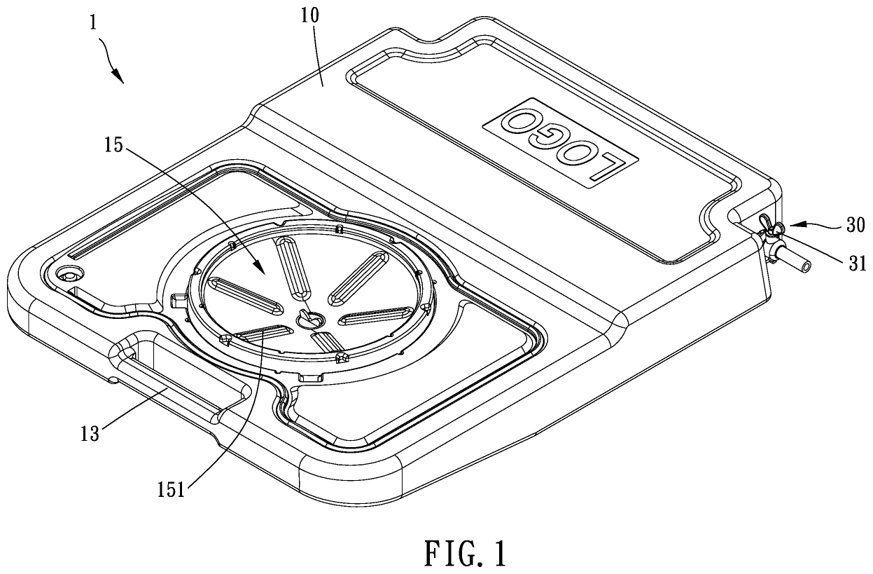

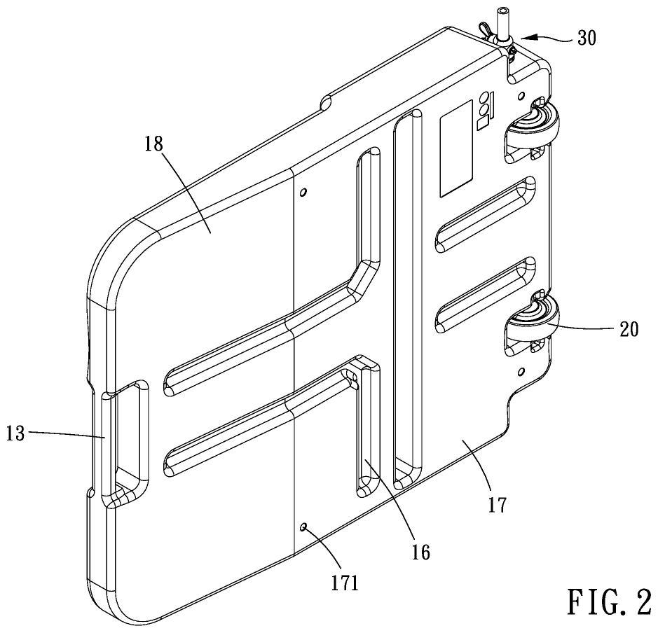

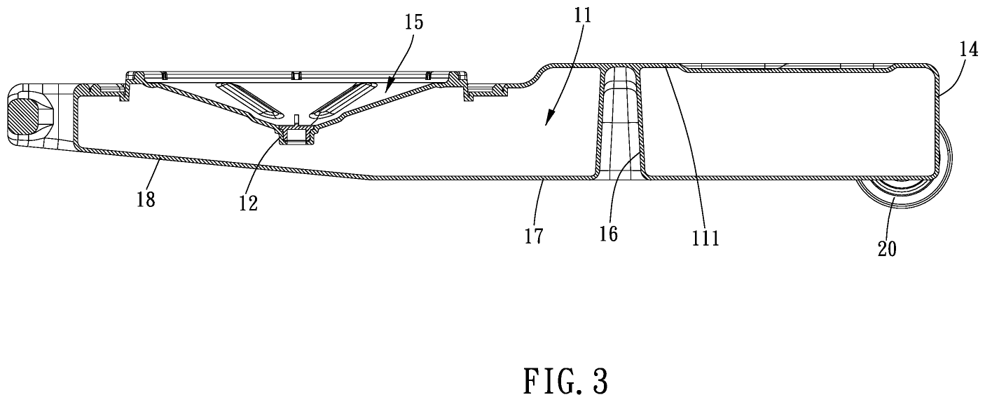

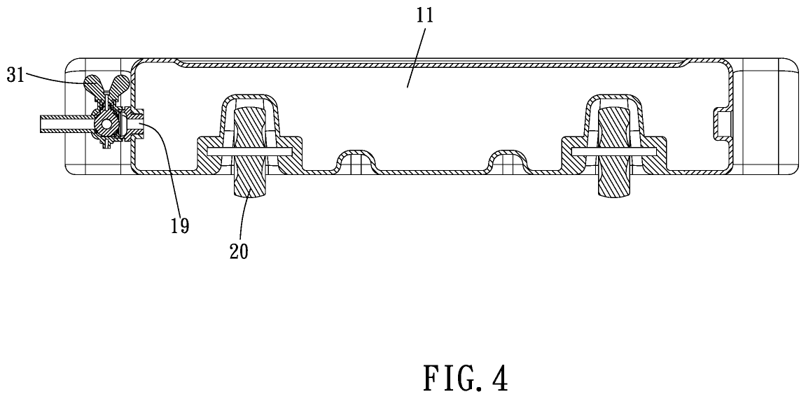

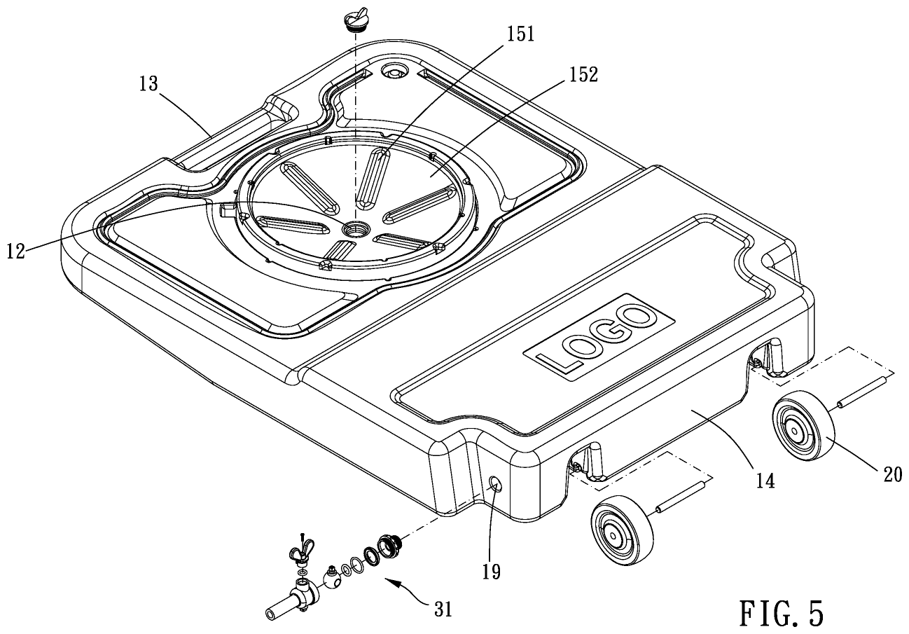

Please refer to FIGS. 1 to 7 for a preferable embodiment of the present invention. A mobile storage device 1 of the present invention includes a receiving body 10 and at least one rotatable member 20.

The receiving body 10 includes an inner space 11, an inlet 12 which is communicated with the inner space 11, a holding portion 13 and a side face 14 which is opposite to the holding portion 13. The at least one rotatable member 20 is disposed on the receiving body 10 and protrudes beyond the receiving body 10, and the inlet 12 is located between the at least one rotatable member 20 and the holding portion 13 so that the mobile storage device 1 can rest upright and is convenient for movement.

In this embodiment, the receiving body 10 further includes a concave portion 15. The concave portion 15 has the inlet 12 and a plurality of guiding extensions 151 which are disposed radially relative to the inlet 12. Each of the guiding extensions 151 protrudes from the concave portion 15, and neighboring two of the plurality of guiding extensions 151 define a channel 152 therebetween for guiding liquid to the inlet 12. Each of the guiding extensions 151 may or may not be connected with the inlet 12, and the guiding extensions 151 may be a groove. Specifically, the inlet 12 is disposed at a half of the receiving body 10 which is close to the holding portion 13, and the at least one rotatable member 20 is disposed at a half of the receiving body 10 which is away from the holding portion 13. The inner space 11 increases gradually in cross-sectional area in a direction from the holding portion 13 toward the side face 14. The inner space 11 can receive more liquid and the liquid is not easy to spill over from the inlet 12 when the mobile storage device 1 is placed upright. A number of the at least one rotatable member 20 is preferably plural for stable movement.

The receiving body 10 further includes a plurality of reinforcing ribs 16 which extend inward toward the inner space 11. At least one of the plurality of reinforcing ribs 16 extends to contact an inner face 111 of the receiving body 10, which can maintain the inner space 11 and avoid deformation. The at least one rotatable member 20 is closer to the at least one of the plurality of reinforcing ribs 16 which extends to contact the inner face 111 of the receiving body 10 than the holding portion 13. The at least one of the plurality of reinforcing ribs 16 may be configured to block the liquid at its two sides to facilitate the liquid entering the inner space 11 through the inlet 12. Two of the plurality of reinforcing ribs 16 are mirroredly L-shaped and arranged back to back and each extend toward the holding portion 13, which improves structural strength of the receiving body 10 and provide guidance effect.

The receiving body 10 further includes a lateral face 17 which is located at a side opposite to the inlet 12 and close to the at least one rotatable member 20 and a inclined face 18 which extends obliquely from the lateral face 17 toward the holding portion 13. The at least one rotatable member 20 protrudes beyond the lateral face 17 to prevent the lateral face 17 from abrasion and increase the convenience when moving the mobile storage device 1. Moreover, the at least one rotatable member 20 protrudes beyond two adjacent lateral face of the receiving body 10, and the two lateral faces include the side face 14. In this embodiment, the two lateral faces are the lateral face 17 and the side face 14 so that the two lateral faces are not easy to be abraded by the ground, it advantages the at least one rotatable member 20 to move and the mobile storage device can be dragged upright. However, the two lateral faces may be the side face and any one of the lateral faces adjacent to the side face. In other embodiments, the receiving body may have at least three rotatable members protruding beyond the side face so that the side face is spaced from the ground and the mobile storage device which is upright with the at least three rotatable members resting on the ground can be moved to improve operating convenience.

The receiving body 10 further includes an outlet 19 near the side face 14 so that the liquid can be discharged from the outlet 19 by setting the mobile storage device 1 upright and without human support or inversion of the mobile storage device 1. In this embodiment, the receiving body 10 further includes a notched portion 30, an outlet 19 which is disposed within the notched portion 30 and a switching mechanism 31 which is connected to the outlet 19. The switching mechanism 31 is preferably a valve, and it may be a plug cap, a screw cap or the like. Preferably, the switching mechanism 31 is entirely located in the notched portion 30 to prevent the switching mechanism 31 from damage caused by collision or inadvertent liquid leakage. The notched portion 30 is preferably adjacent to the side face 14 to facilitate liquid discharge.

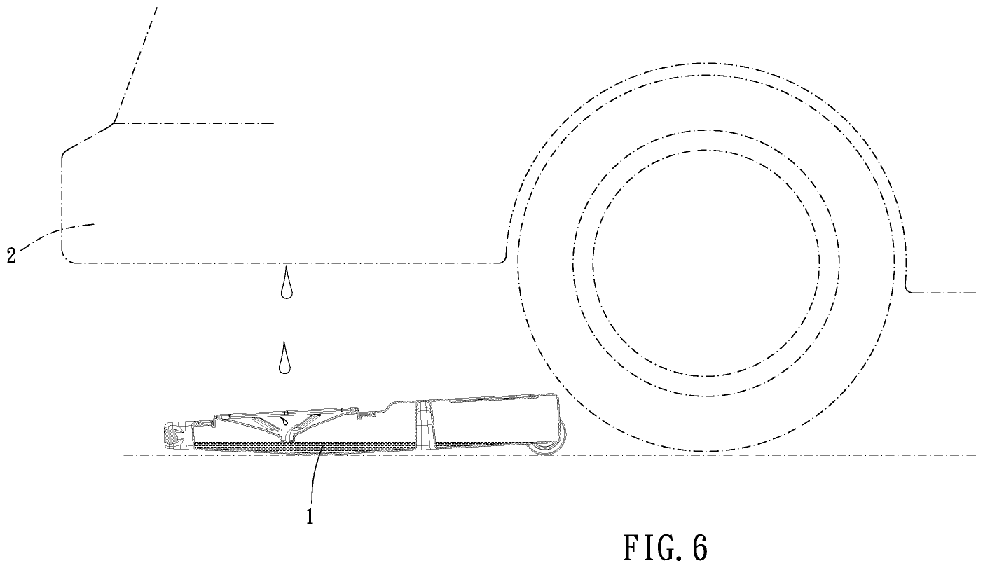

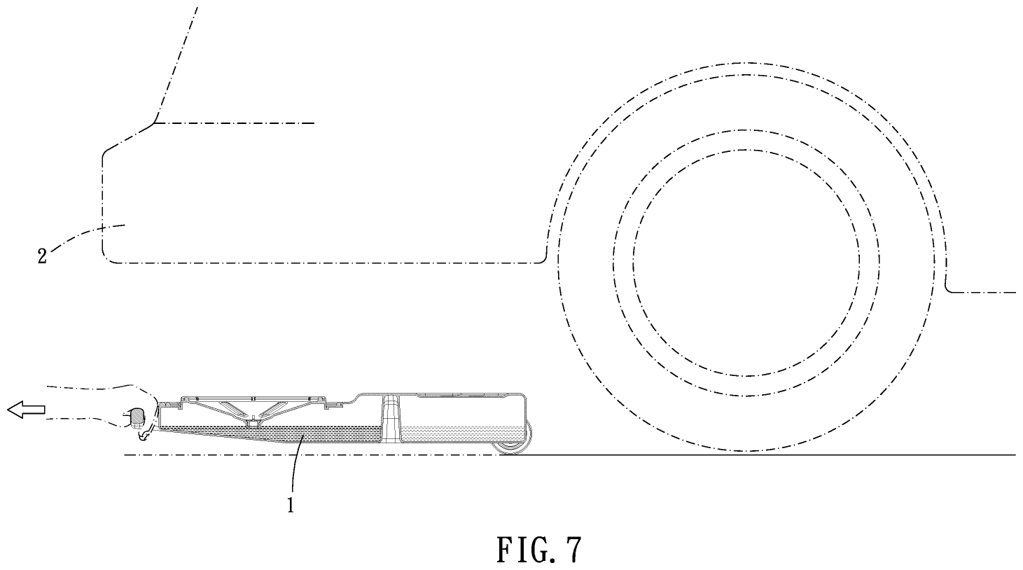

With reference to FIG. 6 and FIG. 7, an user may hold the holding portion 13 and move the mobile storage device 1 to be under the bottom of a car 2 (or other objects) via the at least one rotatable member 20, and the concave portion 15 is aligned with a discharge position of the car 2 from which liquid (such as oil) discharges so as to receive liquid. After the operation is finished, the mobile storage device 1 is pulled out. Preferably, at least one assembling hole 171 is disposed on the lateral face 17 near the inclined face 18. The at least one assembling hole 171 is configured to be assembled to a support member or a cushion member (such as a support leg or a spacer) so as to improve the stability of the mobile storage device 1 which rests horizontally and prevent the lateral face 17 from being abraded repeatedly and causing damage. However, a location of the assembling hole may be set to a convex portion, and the convex portion may be formed as a part of the receiving body or be connected additionally, which can increase stability and anti-wear effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mobile storage device, including:
a receiving body, including an inner space, an inlet which is communicated with the inner space, a holding portion and a side face which is opposite to the holding portion;
at least one rotatable member, disposed on the receiving body and protruding beyond the receiving body, and the inlet being located between the at least one rotatable member and the holding portion.

2. The mobile storage device of claim 1, wherein the receiving body further includes a concave portion, and the concave portion has the inlet and a plurality of guiding extensions which are disposed radially relative to the inlet.

3. The mobile storage device of claim 1, wherein the receiving body further includes a plurality of reinforcing ribs which extend inward toward the inner space.

4. The mobile storage device of claim 3, wherein at least one of the plurality of reinforcing ribs extends to contact an inner face of the receiving body.

5. The mobile storage device of claim 3, wherein two of the plurality of reinforcing ribs are mirroredly L-shaped and arranged back to back and each extend toward the holding portion vertically.

6. The mobile storage device of claim 1, wherein the receiving body further includes a lateral face which is located at a side opposite to the inlet and close to the at least one rotatable member and a inclined face which extends obliquely from the lateral face toward the holding portion, and the at least one rotatable member protrudes beyond the lateral face.

7. The mobile storage device of claim 1, wherein the at least one rotatable member protrudes beyond two adjacent lateral faces of the receiving body, and the two lateral faces include the side face.

8. The mobile storage device of claim 4, wherein the receiving body further includes a concave portion, the concave portion has the inlet and a plurality of guiding extensions which are disposed radially around the inlet; each of the guiding extensions protrudes from the concave portion, neighboring two of the plurality of guiding extensions define a channel therebetween; the inlet is disposed at a half of the receiving body which is close to the holding portion, the at least one rotatable member is disposed at a half of the receiving body which is away from the holding portion; two of the plurality of reinforcing ribs are mirroredly L-shaped and arranged back to back and each extend toward the holding portion vertically; the receiving body further includes a lateral face which is located at a side opposite to the inlet and close to the at least one rotatable member and a inclined face which extends obliquely from the lateral face toward the holding portion, and the at least one rotatable member protrudes beyond the lateral face; at least one assembling hole is disposed on the lateral face and near the inclined face; the at least one rotatable member protrudes beyond two adjacent lateral faces of the receiving body, and the two lateral faces includes the side face; the inner space increases gradually in cross-sectional area in a direction from the holding portion toward the side face; the at least one rotatable member is closer to the at least one of the plurality of reinforcing ribs which extends to contact the inner face of the receiving body than the holding portion.

9. The mobile storage device of claim 1, wherein the receiving body further includes an outlet near the side face.

10. The mobile storage device of claim 1, wherein the receiving body further includes a notched portion, an outlet which is disposed within the notched portion and a switching mechanism which is connected to the outlet, and the switching mechanism is entirely located in the notched portion.
